(19) United States
(12) Patent Application Publication
(10) Pub. No.: US 2012/0246623 A1
(43) Pub. Date: Sep. 27, 2012

(54) APPLICATION INTEGRATED ISSUE MANAGEMENT

(76) Inventor: Christopher T. Creel, Birmingham, AL (US)

(21) Appl. No.: 13/071,786

(22) Filed: Mar. 25, 2011

(51) Int. Cl. G06F 9/44

(52) U.S. Cl. 717/128

(57) ABSTRACT

The disclosed embodiments relate to an application integrated issue management system wherein a given computer software program includes, in addition to the particular functionality for which the program was designed, integrated issue reporting and tracking functions which allow a user to both report issues, e.g. bugs, defects, enhancements, new function requests, user inquiries, user comments, or combinations thereof, to the software developer's project management system, as well as track previously submitted issue reports in the developer's project management system, without having to leave or otherwise terminate the computer software program. Thereby, a convenient mechanism for reporting and tracking issues is provided which encourages participation by the user of the computer software program. Additional functionality may also be provided, also within the context of the computer software program, such as allowing the user to view issue reports submitted by other users or to assist the developer in selecting which issues to address first, such as by voting on, or ranking, those issues which the user thinks are significant. Further, automated monitors may monitor operation of the computer software program to look for operational patterns, such as inter-operational latencies, which may be indicative of a problem. Upon detection of a suspect pattern of operation, an issue report may be automatically generated and submitted. Suspect patterns may be defined by the developer and/or by the user, such as based on provisions of a service level agreement between the user and the developer defining, for example, tolerances for inter-operational latencies or other operational parameters.

### BACKGROUND

Issue management is an important part of computer software program development. Issues may include defects in the program or requests for enhanced, or additional, functions, user inquires and/or user comments. As the speed of software development and competition among software publishers increases at non-linear rates, software developers are often racing to get basic functionality in front of users to establish market share as quickly as possible. The resulting process of implementing new features while obtaining feedback and communicating with users on existing features becomes a hyper-cycle of communication. Accordingly, it is likely that a user of the computer software program will encounter a defect during its operation, contemplate an enhanced or new function to be added which the software's developer did not consider or did not think would be desired, or simply have a question or comment that could spark additional innovation. Without some mechanism that can move as fast as the speed of competition, software development, and the tidal wave of enhancement requests, good ideas or software defects may be lost. Typically, users make the developer aware of such issues by submitting an issue report, such as via a web or email based submission mechanism. Such reports are typically captured by an issue or project management system, a specialized computer software program, which provides the submission mechanism, collects and tracks submissions and otherwise manages the process by which issues are addressed and corrected by the developer. Alternatively, smaller developers may simply utilize a designated email in-box to collect issue reports submitted via email. Regardless of the implementation, systems and methods for capturing and managing issue reports from users may provide an important feedback mechanism to the developer, especially for large scale deployments, to help test, debug and improve their product and generally improve its marketability and competitiveness. As issue reporting is a largely voluntary exercise by an uncompensated user who has likely paid for the software for which they now have to report a problem and wherein the only benefit to the user is the chance that the developer will address the user's issue in a timely manner, it is important that the process by which a user reports an issue is as convenient and non-disruptive as possible, e.g. today's users are often working in 15 second increments or less, so if it takes them more than 15 seconds to suggest an idea or report a problem, they likely will not do it.

### BRIEF DESCRIPTION OF THE DRAWINGS

FIG. 1 shows an exemplary computer having a computer software program stored therein according to one embodiment.

FIG. 2 shows a flow chart depicting operation of an application according to one embodiment.

FIG. 3 shows a block diagram depicting operation of an exemplary application according to one embodiment.

FIGS. 4-11 depict exemplary screen displays of a graphic user interface of the application of FIG. 3, according to one embodiment.

FIG. 12 depicts a more detailed diagram of the computer shown in FIG. 1.

### DETAILED DESCRIPTION OF THE DRAWINGS AND PRESENTLY PREFERRED EMBODIMENTS

The disclosed embodiments relate to an application integrated issue management system wherein a given computer software program includes, in addition to the particular functionality for which the program was designed, integrated issue reporting and tracking functions which allow a user to both report issues, e.g. bugs, defects, enhancements, new function requests, user inquiries, user comments, or combinations thereof, to the software developer's project management system, as well as manage, e.g. track, comment, etc., previously submitted issue reports in the developer's project management system, without having to leave or otherwise terminate the computer software program. Thereby, a convenient mechanism, i.e. one that keeps pace with the speed at which users expect to operate, for reporting and tracking issues is provided which encourages participation by the user of the computer software program. Additional functionality may also be provided, also within the context of the computer software program, such as allowing the user to view issue reports submitted by other users or to assist the developer in selecting which issues to address first, such as by voting on, or ranking, those issues which the user thinks are significant. Further, automated monitors may monitor operation of the computer software program to look for operational patterns, such as inter-operational latencies, which may be indicative of a problem. Upon detection of a suspect pattern of operation, an issue report may be automatically generated and submitted. Suspect patterns may be defined by the developer and/or by the user, such as based on provisions of a service level agreement between the user and the developer defining, for example, tolerances for inter-operational latencies or other operational parameters. In this way, the user is able to see and manage issues they created, that were automatically created through automated monitoring, or issues that were created by other users, all without ever leaving the application.

Prior issue management functionality required submission and management of issue reports via a communication channel independent of the system/software to which the report related, such as via a web site/web browser program or by email/email client program. As such, the user was required to exit or otherwise switch from the application context, to which the issue was relevant, to a separate program, such as a web browser or email program, in order to submit an issue report or otherwise track or follow up on the status of a previously submitted report, such as via the application publisher's/developer's issue management system. In multitasking environments/operating systems, the perception of exiting the application context, even if the application may continue executing, may be a minor inconvenience to some users while others may consider this a significant disruption. In uni-tasking or pseudo multi-tasking environments/operating systems, such as with mobile device operating systems, exiting the application to submit or track an issue report may be considered cumbersome, inconvenient and disruptive to a user's/application's workflow, especially if the application must be restarted or the user's operating state is lost and must be restored. In either case, such inconveniences and disruptions may discourage issue submissions and, consequently, hinder defect detection, resolution and overall application development and feature evolution, thereby detracting from the value of the software both to current and future users.

Some computer software applications and operating systems integrate methods of issue submission, such as by providing a function which causes an external email program to initiate a issue report email message, causes the execution of, and context switch to, a web browser program which is directed to an issue submission interface, web page/browser, or otherwise facilitates submission via an independent communications channel. However, the function of issue submission is largely separate from the application and results in an undesirable context switch to a another application or context, as was described above. Further, such submission mechanisms do not facilitate subsequent submission tracking or additional management functionality, such as cross-user submission review and assessment, collaborative development (bidirectional/conversation), automated pattern detection and issue submission, e.g. SLA violations, etc., all of which further encourage user participation and collaboration in the development process, which further adds value thereto. For example, applications which support “in application” issue reporting are limited to defect reporting only and to a one-way communication from the application to the developer/defect report repository. In order to see submitted issues the user would have to switch from the application/context to another interface/context enabling them to see the issues that they submitted.

Some test management software programs, i.e. computer software programs designed to manage the testing of other computer software programs, integrate the issue submission and tracking functions of the developer's project management system, so that the software testers can conveniently report and track problems that they detect during their testing process. One such program is TestRail published by Gurock Software GmbH, located in Bad Sassendorf, Germany, which features custom defect “plug in's” which provide defect tracking integration with their test management system. However, such programs still require that the user, i.e. the software tester, switch from the software program undergoing testing, to the test management software program in order to submit or track an issue.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superceding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

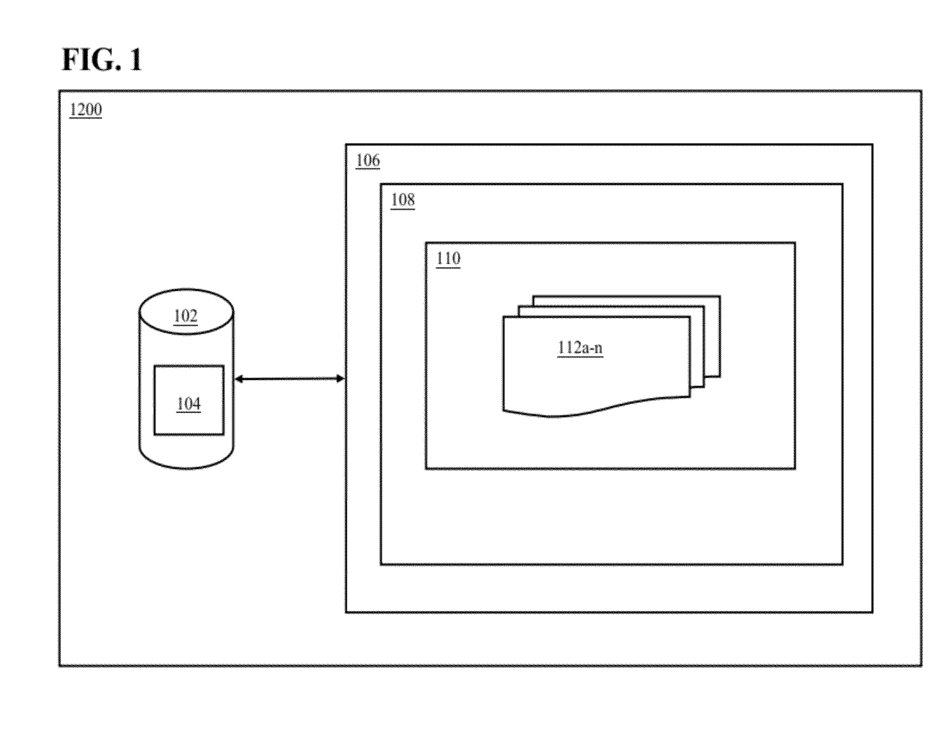

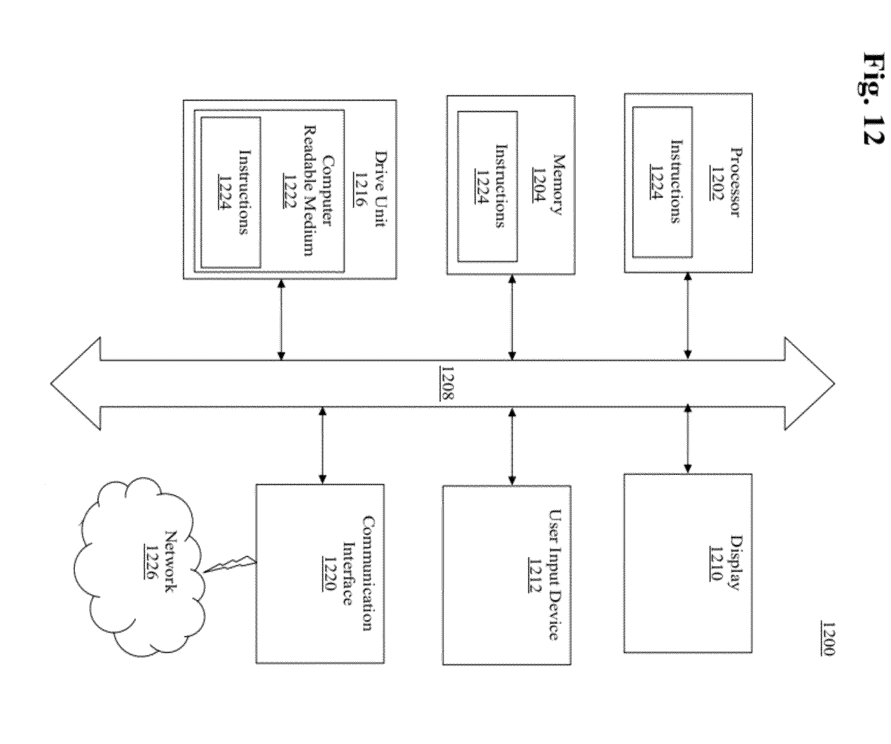

Referring to FIG. 1, there is shown a computer 1200, described in more detail below with respect to FIG. 12, which is configured with a computer software program 104, also referred to as instructions, an application, computer application, computer application program or application program, having program code or logic stored in a memory 102, or other storage device, such as the memory 1204 or storage device 1216 shown in FIG. 12 and described in more detail below, for execution within an operating system 108 by a processor 106, such as the processor 1202 described in more detail below. The computer software program 104 includes self contained issue reporting and tracking functions which do not require the user to terminate or otherwise leave the executing instance of the program to report and track issues. In particular, FIG. 1 shows a computer software program 104 stored in a memory 102, or other storage, and executable in conjunction with an operating system program 108, such as Microsoft Windows™, published in various versions such as XP or 7 by Microsoft Corporation located in Redmond Wash., or Mac OS or iOS published by Apple Computer Inc. located in Cupertino, Calif., by a processor 106 coupled with the memory 102, to instantiate a context 110 distinct from the operating system program 108, or context created thereby. Herein, the phrase “coupled with” is defined to mean directly connected to or indirectly connected through one or more intermediate components. Such intermediate components may include both hardware and software based components.

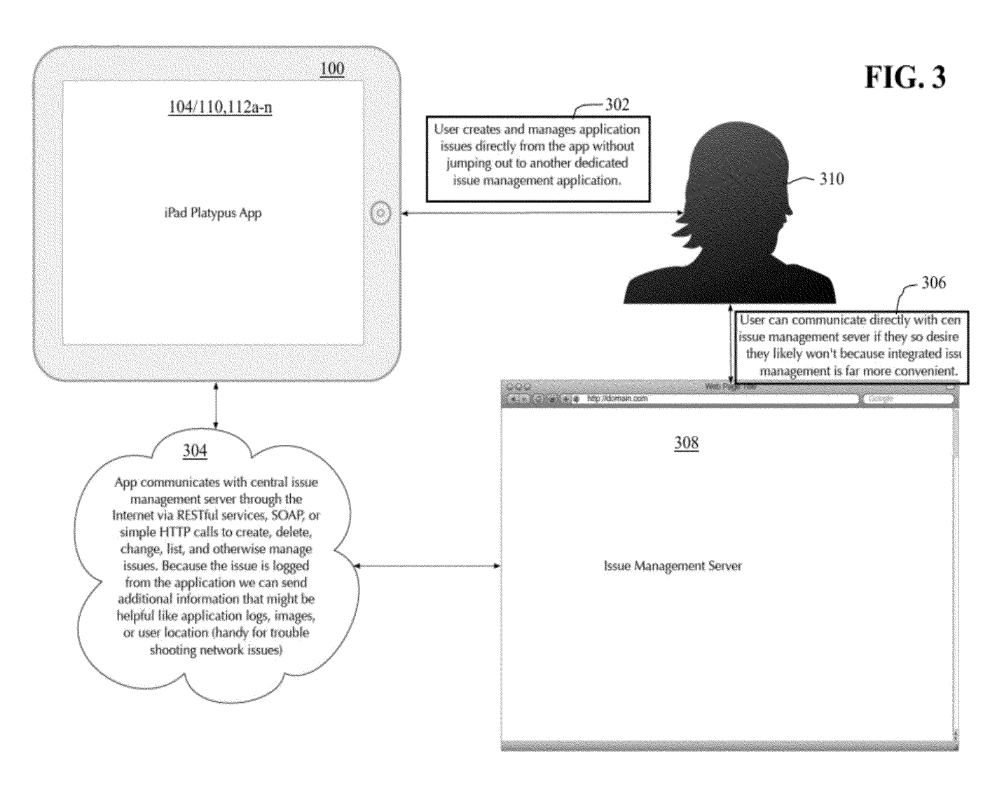

The computer software program 104 includes first logic (not shown) stored in the memory 102, such as in object code, binary, etc., and executable by the processor 106 to provide, within the executing program's context 110, a plurality of related functions 112a-n operative to accomplish a plurality of related tasks for which the program was designed, wherein at least one of the plurality of related functions 112a-n may be caused by a user to be performed to accomplish the related task of the plurality of related tasks. In one embodiment, the computer software program 104 is the DSTHS Platypus App published by DST Health Solutions, located in Birmingham, Ala., referred to herein as the “Platypus App” and for which exemplary screen displays are shown in FIGS. 3-11, executable under the Apple iOS operating system, such as on iPad or iPhone device, to provide users with functions for accessing DST Health Solutions' Innovation Toolkit Platform for outsourced data management of health care claims processing.

While a majority of the plurality of related functions may be operative to accomplish tasks for which the program was designed, at least one of the plurality of related functions 112a-n includes causing a report to be generated relating to an issue with another of the plurality of functions 112a-n, such as a defect, functional enhancement, new function, user inquiry, user comment, or combination thereof. In one embodiment, the report may further include, such as by automated or manual inclusion, contextual data related to the issue, such as a screen capture, an error message, an error code, computer program code, a log file, or combinations thereof. At least one other of the plurality of related functions includes causing presentation of a status of a previously generated report relating to an issue with another of the plurality of functions 112a-n. These functions are operative to be performed without leaving the context 110 and may be further operative to interact with an issue management system external to the context 110, such as the Jira project management system, developed by Atlassian Pty Ltd., located in Sydney, Australia, commonly used for bug tracking, issue tracking, and project management. In particular, the function for generating an issue report may further include submitting the report to the issue management system. In addition, the function to cause presentation of previously submitted reports may further include retrieving a list of previously generated reports from the issue management system, each characterized by a status, e.g. pending or resolved. The previously generated reports may be limited to only those reports submitted by the user or may include issue reports submitted by other users, from the current context 110 or another instantiation of the context. The user may apply a filter to control which reports are presented, such as based on a criterion that a report must meet, e.g. submitting user, date, status, etc. These functions permit a user community to review issue report submission across the community, thereby allowing users to see issues they may not yet have encountered.

In one embodiment, one of the plurality of related functions may include receiving a comment regarding a previously generated report, such as a recommendation for changing a handling priority of the issue associated with the previously generated report. In this way, users may review submissions of other users and vote on which submissions the developer should act upon first. This facilitate collaborative prioritization and ensures that the developer addresses the greatest need first. Alternatively, or in addition thereto, the commenting function permits users to provide suggested solutions or other information related to the issue which may be of assistance to the developer or the user who submitted the issue.

In one embodiment, automated or semi-automated issue report submission may be provided. For example, the developer and/or user may be permitted to specify patterns of application behavior, e.g. criteria or parameters, such as inter-operational latencies, which, if detected, will cause an issue report to be submitted. For example, the user may have a service level agreement in place with the developer which specifies certain operational requirements of the application, such as the time between activating a particular function and seeing a result therefrom, or a particular transaction processing rate, etc. The user and/or developer may be able to specify these operational requirements in the application such that a failure to meet one or more of the requirements causes an issue report to be submitted.

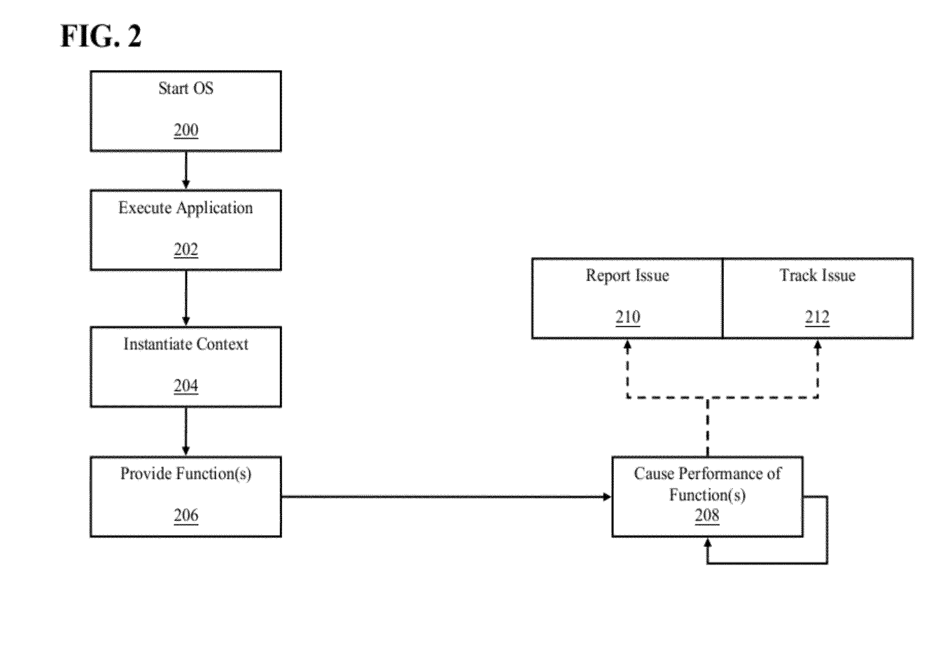

Referring to FIG. 2, there is shown a flow chart depicting operation of disclosed application having integrated issue reporting and tracking functions. The operations include: executing a computer software program 104 stored in a memory 102 to instantiate a context 110 in conjunction with an operating system program 108, the context being distinct therefrom; and providing, by the computer software program 104 within the context 110, a plurality of related functions 112a-n operative to accomplish a plurality of related tasks, wherein at least one of the plurality of related functions may be caused by a user to be performed to accomplish the related task of the plurality of related tasks and wherein at least two of the plurality of related functions comprise causing a report to be generated relating to an issue with another of the plurality of functions, such as a defect, functional enhancement, new function, user inquiry, user comment, or combination thereof, and causing presentation of a status of a previously generated report relating to an issue with another of the plurality of functions, the at least two of the functions operative to be performed without leaving the context. In one embodiment, the submitted issue report may further include contextual data related to the issue, such as a screen capture, an error message, an error code, computer program code, a log file, or combinations thereof. In one embodiment, the functions for submitting an issue report and displaying previously submitted reports may be further operative to interact with an issue management system external to the context 110, such as by submitting the report to the issue management system and/or retrieving a list of previously generated reports, submitted by the current user or one or more other users, from the issue management system, each characterized by a status, e.g. pending or resolved. Filtering functionality may be provided such that the causing of presentation of the status of a previously generated report further includes causing presentation of the status of only specified previously generated reports, such as based on at least one criterion which a previously generated report must meet.

In one embodiment, user collaboration functionality is provided which includes receiving a comment regarding a previously generated report, such as a recommendation for changing a handling priority of the issue associated with the previously generated report. As was described above, this permits a community of users to collaborate on the priority of issue submissions, etc. Alternatively, or in addition thereto, the commenting function permits users to provide suggested solutions or other information related to the issue which may be of assistance to the developer or the user who submitted the issue.

FIG. 3 shows a block diagram depicting operation of the computer software program 104, such as the Platypus App, described above, context 110 operating on a computer 100, such as an iPad manufactured by Apple Computer, Inc., located in Cupertino, Calif., executing the iOS operating system, also published by Apple Computer, Inc. As shown in the diagram, a user, via the functions 112a-n provided within the context 110, creates and manages application issues directly from the app 104/110 without jumping out to another dedicated issue management application (block 302). The app 104/110 communicates with a central issue management program or server (not shown), such as the Jira project management system, described above, via a wired and/or wireless network, such as the Internet, using a communication protocol, such as Representational State Transfer (“RESTful”) services, Simple Object Access Protocol (“SOAP”), simple HTTP calls, or combinations thereof, to view, create, delete or otherwise modify and manage issues. Because the issue may be submitted via the app 104/110, additional information can be submitted with the issue report to the issue management server, such as application logs, screen captures or other images, or other log date, context data, state data, or combinations thereof (block 304). It will be appreciated that the user 310 is also free to communicate directly with the issue management server if they wish, such as via a web page portal 308 (block 306).

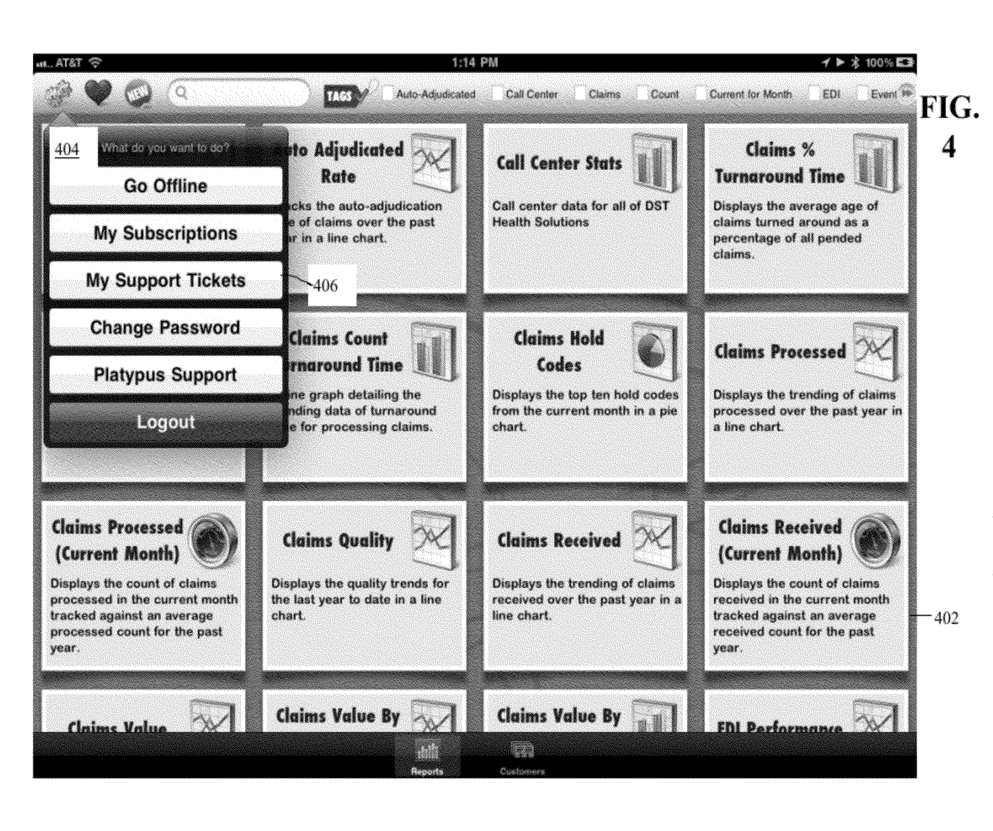

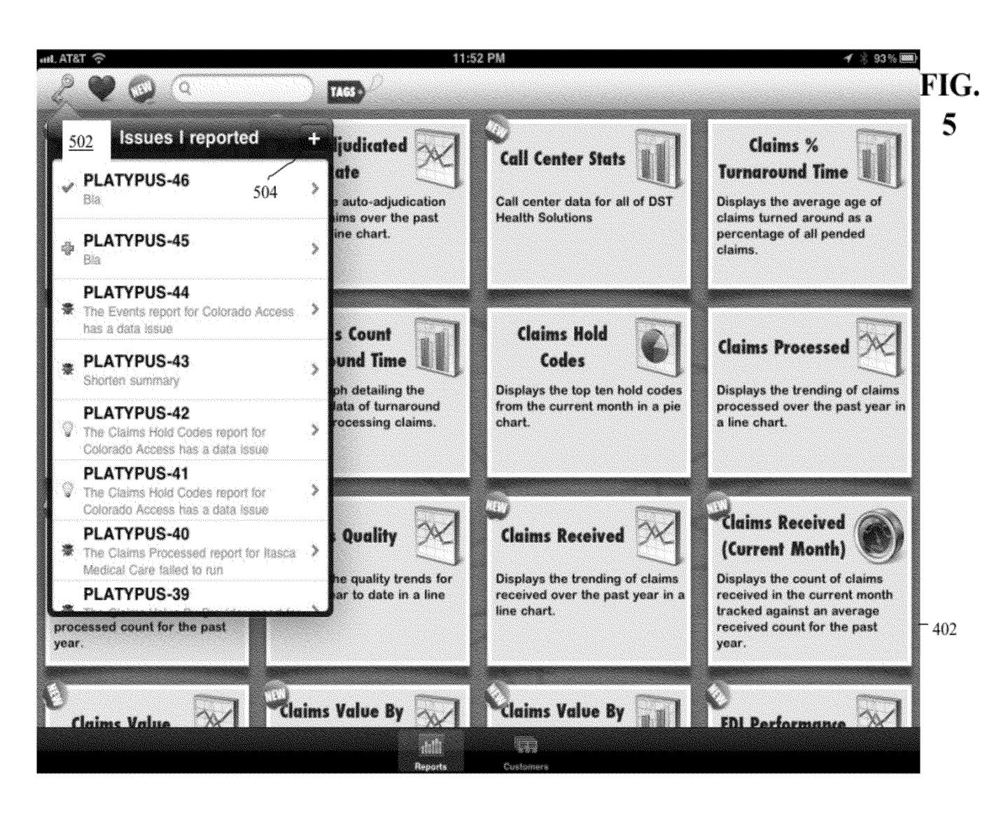

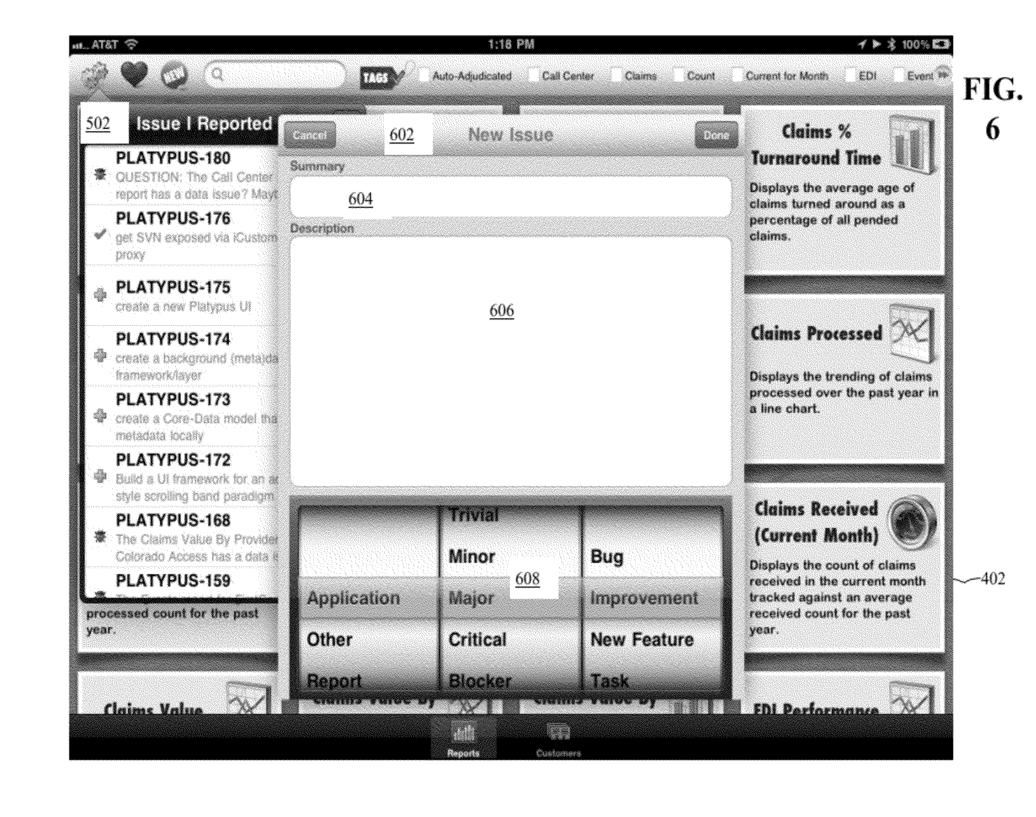

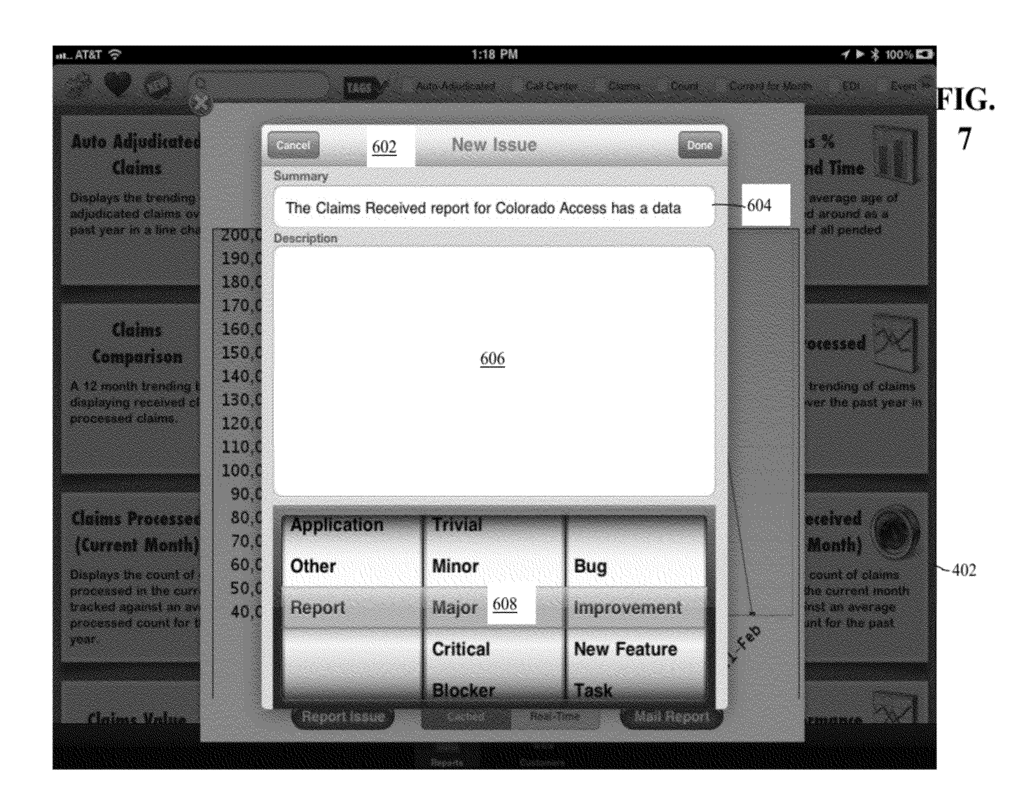

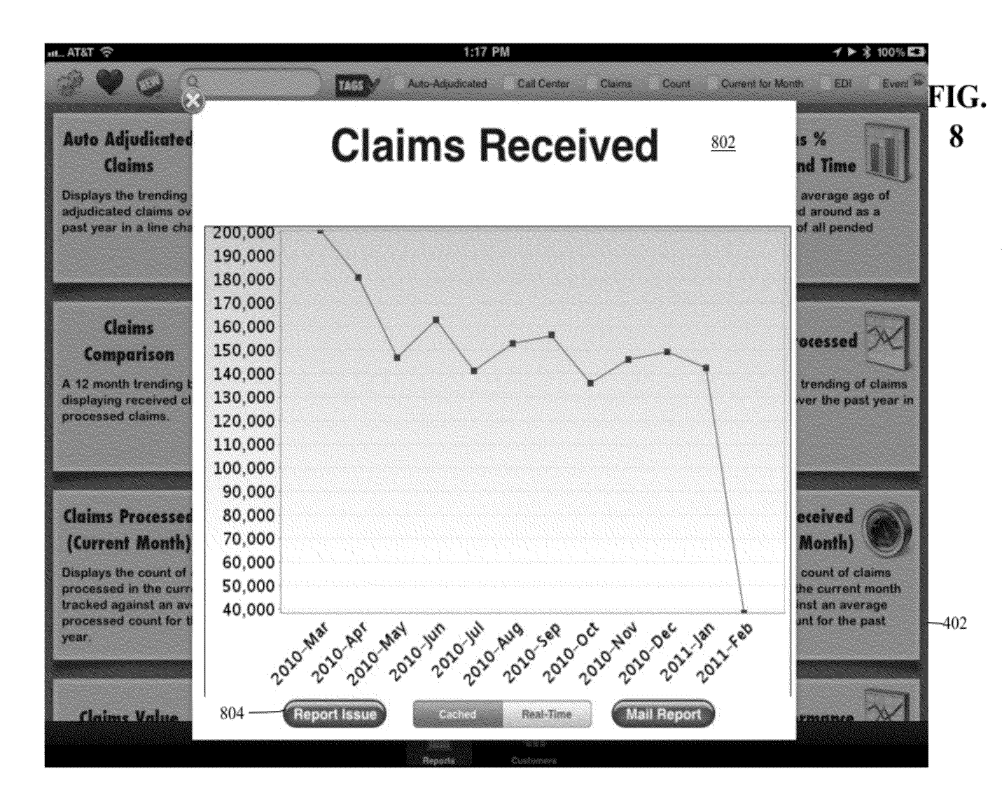

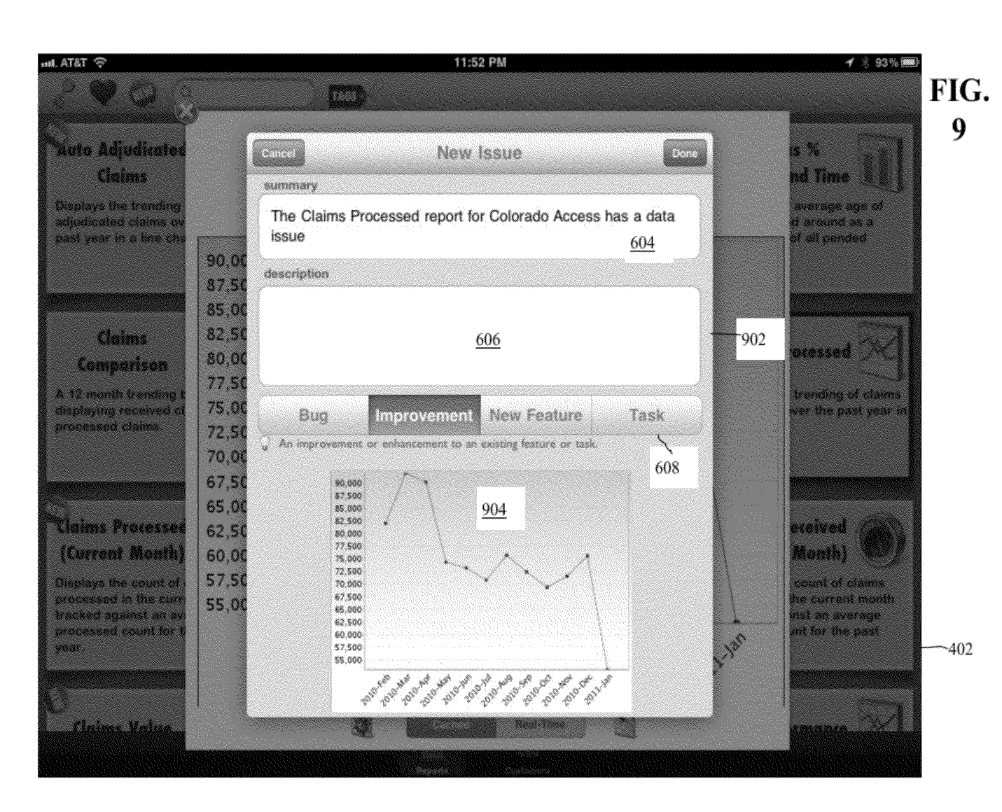

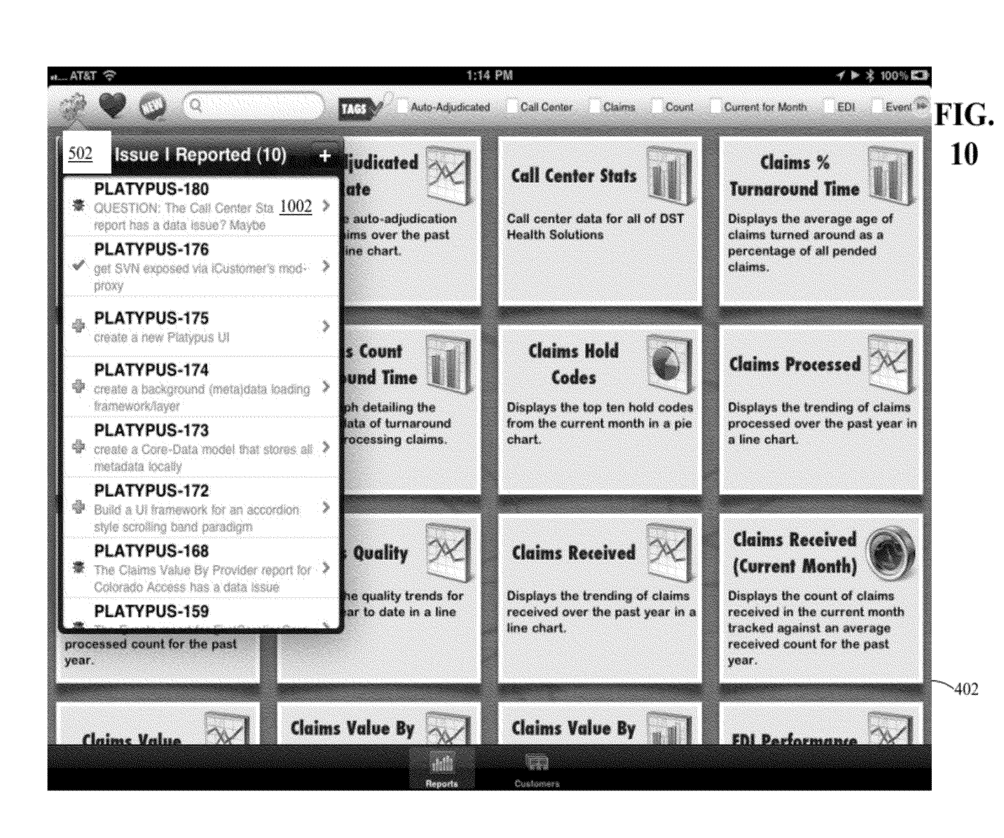

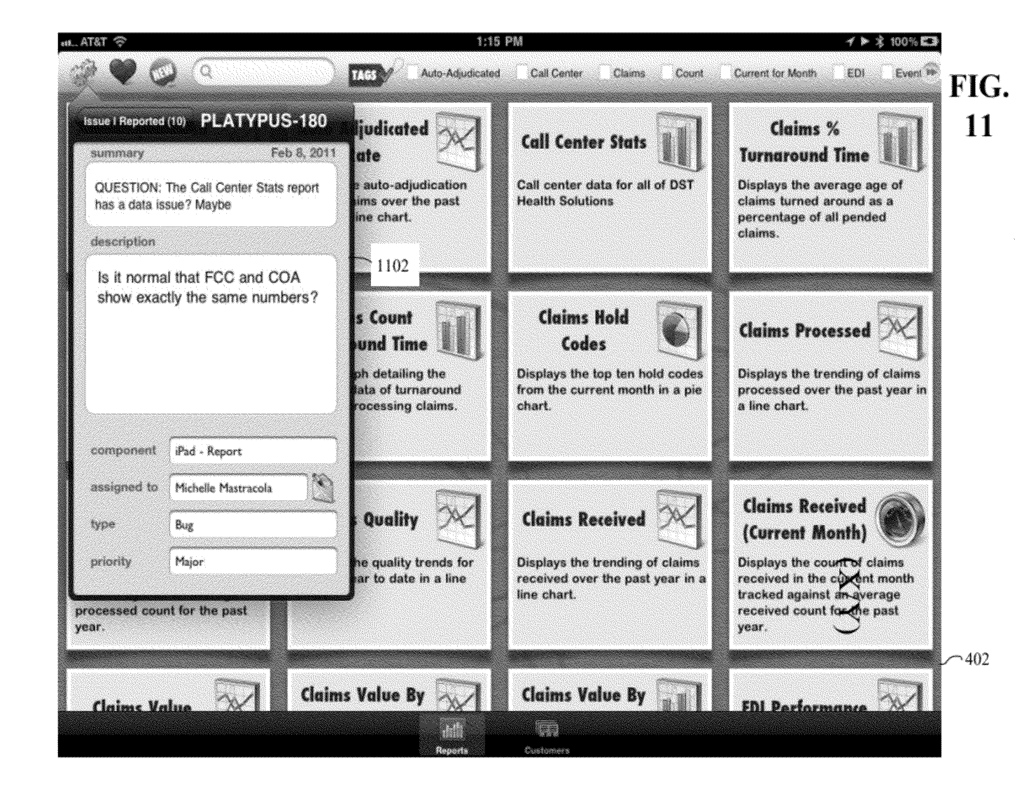

FIGS. 4-11 depict exemplary screen images of the graphic user interface of the Platypus app demonstrating the various functions provided thereby. FIG. 4 shows a portion of the function selection display 402 from which the user may select various functions of the app to cause the performance thereof. FIG. 4 also shows a optionally displayable menu 404 from which the user may access additional functions such as the function 406 to display submitted issue reports. FIG. 5 depicts the resultant issue report list 502 which is displayed when the user causes the function 406 to display submitted issue reports to be performed. The list 502 further provides an additional function 504, represented by the “+” button graphic user interface element, which allows the user to create a new issue report. FIGS. 6 and 7 show the user input window 602 which is displayed when the user chooses to create a new issue report. The input window 602 features input areas to receive a summary of the issue 604 (as shown in FIG. 7) and a detailed description of the issue 606. Selector interface elements 608 are further provided to allow the user to select the category or other characteristics of the issue from a constrained list of available choices which may be set by the developer. For example, the user may select which area of the application the issue relates to, the importance of the issue, e.g. minor, major, critical, and/or the type of issue, e.g. bug or improvement. FIG. 8 depicts a display/window 802 resulting from exemplary function provided by the Platypus app to view a graph of the number of claims received over time. The window 802 provides additional functions including the function to report an issue 804. FIG. 9 depicts an exemplary display/window 902, similar to the window 602 shown in FIGS. 6 and 7, which is displayed in response to the user selecting the function to report an issue 804 shown in FIG. 8. The issue report display 902 is automatically populated with a screen capture 904 of the graph displayed in the window 802 from where the user selected the function to report an issue 804. FIGS. 10 and 11 depict the function of selecting an existing issue report from a display of previously submitted issue reports 1004 and causing the selected issue report to be displayed for review 1102.

Referring to FIG. 12, an illustrative embodiment of a general computer system 1200 is shown. The computer system 1200 can include a set of instructions that can be executed to cause the computer system 1200 to perform any one or more of the methods or computer based functions disclosed herein, such as the application program 104 described above. The computer system 1200 may operate as a standalone device or may be connected, e.g., using a network, to other computer systems or peripheral devices.

In a networked deployment, the computer system 1200 may operate in the capacity of a server or as a client user computer in a client-server user network environment, or as a peer computer system in a peer-to-peer (or distributed) network environment. The computer system 1200 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 1200 can be implemented using electronic devices that provide voice, video or data communication. Further, while a single computer system 1200 is illustrated, the term “system” shall also be taken to include any collection of systems or sub-systems that individually or jointly execute a set, or multiple sets, of instructions to perform one or more computer functions.

As illustrated in FIG. 12, the computer system 1200 may include a processor 1202, e.g., a central processing unit (CPU), a graphics processing unit (GPU), or both. The processor 1202 may be a component in a variety of systems. For example, the processor 1202 may be part of a standard personal computer or a workstation. The processor 1202 may be one or more general processors, digital signal processors, application specific integrated circuits, field programmable gate arrays, servers, networks, digital circuits, analog circuits, combinations thereof, or other now known or later developed devices for analyzing and processing data. The processor 1202 may implement a software program, such as code generated manually (i.e., programmed).

The computer system 1200 may include a memory 1204 that can communicate via a bus 1208. The memory 1204 may be a main memory, a static memory, or a dynamic memory. The memory 1204 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 1202. In alternative embodiments, the memory 1204 is separate from the processor 1202, such as a cache memory of a processor, the system memory, or other memory. The memory 1204 may be an external storage device or database for storing data. Examples include a hard drive, solid state memory/disk, compact disc (“CD”), digital video disc (“DVD”), memory card, memory stick, floppy disc, universal serial bus (“USB”) memory device, or any other device operative to store data. The memory 1204 is operable to store instructions executable by the processor 1202. The functions, acts or tasks illustrated in the figures or described herein may be performed by the programmed processor 1202 executing the instructions stored in the memory 1204. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1200 may further include a display unit 1214, such as a liquid crystal display (LCD), an organic light emitting diode (OLED), a flat panel display, a solid state display, a cathode ray tube (CRT), a projector, a printer or other now known or later developed display device for outputting determined information. The display 1214 may act as an interface for the user to see the functioning of the processor 1202, or specifically as an interface with the software stored in the memory 1204 or in the drive unit 1206.

Additionally, the computer system 1200 may include an input device 1216 configured to allow a user to interact with any of the components of system 1200. The input device 1216 may be a number pad, a keyboard, or a cursor control device, such as a mouse, or a joystick, touch screen display, remote control or any other device operative to interact with the system 1200.

In a particular embodiment, as depicted in FIG. 12, the computer system 1200 may also include a disk, solid state disk or optical drive unit 1206. The disk drive unit 1206 may include a computer-readable medium 1210 in which one or more sets of instructions 1212, e.g. software, can be embedded. Further, the instructions 1212 may embody one or more of the methods or logic as described herein. In a particular embodiment, the instructions 1212 may reside completely, or at least partially, within the memory 1204 and/or within the processor 1202 during execution by the computer system 1200. The memory 1204 and the processor 1202 also may include computer-readable media as discussed above.

The present disclosure contemplates a computer-readable medium that includes instructions 1212 or receives and executes instructions 1212 responsive to a propagated signal, so that a device connected to a network 1220 can communicate voice, video, audio, images or any other data over the network 1220. Further, the instructions 1212 may be transmitted or received over the network 1220 via a communication port 918. The communication port 1218 may be a part of the processor 1202 or may be a separate component. The communication port 1218 may be created in software or may be a physical connection in hardware. The communication port 1218 is configured to connect with a network 1220, external media, the display 1214, or any other components in system 1200, or combinations thereof. The connection with the network 1220 may be a physical connection, such as a wired Ethernet connection or may be established wirelessly as discussed below. Likewise, the additional connections with other components of the system 1200 may be physical connections or may be established wirelessly.

The network 1220 may include wired networks, wireless networks, or combinations thereof. The wireless network may be a cellular telephone network, an 802.11, 802.16, 802.20, or WiMax network. Further, the network 1220 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

I claim:

1. A computer software program stored in a memory and executable in conjunction with an operating system program, by a processor coupled with the memory, to instantiate a context distinct from the operating system program, the computer software program comprising:
first logic stored in the memory and executable by the processor to provide, within the context, a plurality of related functions operative to accomplish a plurality of related tasks, wherein at least one of the plurality of related functions may be caused by a user to be performed to accomplish the related task of the plurality of related tasks and wherein at least two of the plurality of related functions comprise causing a report to be generated relating to an issue with another of the plurality of functions and causing presentation of a status of a previously generated report relating to an issue with another of the plurality of functions, the at least two of the functions operative to be performed without leaving the context.

2. The computer software program of claim 1 wherein the issue comprises one of a defect, functional enhancement, new function, user inquiry, user comment, or combination thereof.

3. The computer software program of claim 1 wherein the report further includes contextual data related to the issue.

4. The computer software program of claim 3 wherein the data comprises a screen capture, an error message, an error code, computer program code, a log file, or combinations thereof.

5. The computer software program of claim 1 wherein the at least two of the plurality of related functions are further operative to interact with an issue management system external to the context.

6. The computer software program of claim 5 wherein the causing a report to be generated further comprises submitting the report to the issue management system.

7. The computer software program of claim 5 wherein the causing presentation further comprises retrieving a list of previously generated reports from the issue management system, each characterized by a status.

8. The computer software program of claim 7 wherein the status comprises one of pending or resolved.

9. The computer software program of claim 1 wherein one of the plurality of related functions comprises receiving a comment regarding a previously generated report.

10. The computer software program of claim 9 wherein the comment comprises a recommendation for changing a handling priority of the issue associated with the previously generated report.

11. The computer software program of claim 1 wherein the previously generated report was generated by another user, from another instantiation of the context, or combination thereof.

12. The computer software program of claim 1 wherein the causing of presentation of the status of a previously generated report further comprises causing presentation of the status of only specified previously generated reports.

13. The computer software program of claim 12 wherein the specification of the previously generated reports to present comprises at least one criterion which a previously generated report must meet.

14. A computer implemented method comprising:
executing a computer software program to instantiate a context in conjunction with an operating system program, the context being distinct therefrom; and
providing, by the computer software program within the context, a plurality of related functions operative to accomplish a plurality of related tasks, wherein at least one of the plurality of related functions may be caused by a user to be performed to accomplish the related task of the plurality of related tasks and wherein at least two of the plurality of related functions comprise causing a report to be generated relating to an issue with another of the plurality of functions and causing presentation of a status of a previously generated report relating to an issue with another of the plurality of functions, the at least two of the functions operative to be performed without leaving the context.

15. The computer implemented method of claim 14 wherein the issue comprises one of a defect, functional enhancement, new function, user inquiry, user comment, or combination thereof.

16. The computer implemented method of claim 14 wherein the report further includes contextual data related to the issue.

17. The computer implemented method of claim 16 wherein the data comprises a screen capture, an error message, an error code, computer program code, a log file, or combinations thereof.

18. The computer implemented method of claim 14 wherein the at least two of the plurality of related functions are further operative to interact with an issue management system external to the context.

19. The computer implemented method of claim 18 wherein the causing a report to be generated further comprises submitting the report to the issue management system.

20. The computer implemented method of claim 18 wherein the causing presentation further comprises retrieving a list of previously generated reports from the issue management system, each characterized by a status.

21. The computer implemented method of claim 20 wherein the status comprises one of pending or resolved.

22. The computer implemented method of claim 14 wherein one of the plurality of related functions comprises receiving a comment regarding a previously generated report.

23. The computer implemented method of claim 22 wherein the comment comprises a recommendation for changing a handling priority of the issue associated with the previously generated report.

24. The computer implemented method of claim 14 wherein the previously generated report was generated by another user, from another instantiation of the context, or combination thereof.

25. The computer implemented method of claim 14 wherein the causing of presentation of the status of a previously generated report further comprises causing presentation of the status of only specified previously generated reports.

26. The computer implemented method of claim 25 wherein the specification of the previously generated reports to present comprises at least one criterion which a previously generated report must meet.

27. A computer software application for execution within an operating system of a computer, the computer software application providing a self contained issue reporting and tracking function operable by a user of the computer software application without exiting the application to report and track issues with the computer software application.
